(19) United States
(12) Patent Application Publication
(10) Pub. No.: US 2021/0125063 A1
(43) Pub. Date: Apr. 29, 2021

(54) APPARATUS AND METHOD FOR GENERATING BINARY NEURAL NETWORK

(71) Applicant: Electronics and Telecommunications Research Institute, Daejeon (KR)

(72) Inventor: Jun Yong PARK, Daejeon (KR)

(73) Assignee: Electronics and Telecommunications Research Institute, Daejeon (KR)

(21) Appl. No.: 17/038,894

(22) Filed: Sep. 30, 2020

(30) Foreign Application Priority Data
Oct. 23, 2019 (KR) 10-2019-0132522
Aug. 31, 2020 (KR) 10-2020-0110356

(51) Int. Cl. G06N 3/08; G06N 3/04

(52) U.S. Cl. CPC G06N 3/08; G06N 3/0454

(57) ABSTRACT

A method for generating a binary neural network may comprise extracting real-value filter weights from a first neural network for which inference training has been completed; performing a binary orthogonal transform on the filter weights; and generating a second neural network using binary weights calculated according to the binary orthogonal transform.

### CROSS-REFERENCE TO RELATED APPLICATIONS

This application claims priority to Korean Patent Applications No. 10-2019-0132522 filed on Oct. 23, 2019 and No. 10-2020-0110356 filed on Aug. 31, 2020 with the Korean Intellectual Property Office (KIPO), the entire contents of which are hereby incorporated by reference.

### BACKGROUND

### 1. Technical Field

The present disclosure relates generally to an apparatus and a method for generating a binary neural network, and more specifically, to an apparatus and a method for generating a binary neural network by performing binary transform on a convention artificial neural network.

### 2. Related Art

The convolutional neural network (CNN), which is in the spotlight in the field of artificial intelligence, is overwhelmingly superior to existing artificial intelligence technologies and is developing day by day. However, the CNN needs to be deeper and wider in order to achieve higher performance by training more data. As this phenomenon progresses, the size of the model increases, and the computation time required to process the model also increases. In order to compensate for these shortcomings, various techniques to reduce the model size of the CNN have been proposed. For example, a structure of the CNN itself is designed to be slim (i.e., lightweight), branches of the artificial neural network are randomly pruned to proceed with training, or weight values are quantized to fewer bits (i.e., n-bit quantization).

A typical lightweight neural network is a binary artificial neural network. The binary artificial neural network is an innovative scheme in that it can significantly increase the speed of the existing artificial neural network and significantly reduce the memory capacity of the artificial neural network model. However, there is a disadvantage in that a loss occurs by representing weight values and activation functions, which are conventionally represented as real values (e.g., floating point values), only as binary values (i.e., −1s and 1s). This information loss may lead to a decrease in accuracy as a result, and may result in performance degradation in recognizing or detecting objects.

Focusing on the fact that simple binary transformation is the key to the information loss and accuracy degradation due to the binarization of artificial neural networks, many binary artificial neural networks use amplification/complementary factors to supplement them and solve the information losses. However, it is still very difficult to train a binary artificial neural network because the information losses through the binarization have effects also on the gradients during the training.

### SUMMARY

Accordingly, exemplary embodiments of the present disclosure are directed to providing a binary neural network generating method.

Also, exemplary embodiments of the present disclosure also are directed to providing a binary neural network generating apparatus using the binary neural network generating method.

According to an exemplary embodiment of the present disclosure, a method for generating a binary neural network may comprise extracting real-value filter weights from a first neural network for which inference training has been completed; performing a binary orthogonal transform on the filter weights; and generating a second neural network using binary weights calculated according to the binary orthogonal transform.

The first neural network may be a convolutional neural network, and the filter weights may include multiplicative factors and a constant factor of convolution filters.

The performing of the binary orthogonal transform on the filter weights may comprise generating a binary orthogonal vector; generating at least one binary filter by extracting each column of the binary orthogonal vector; and calculating binary multiplicative factors and a binary constant factor using the at least one binary filter.

The binary multiplicative factors and the binary constant factor may be generated using an equation represented using a vector for a real-value convolution filter included in the first neural network, a vector for the at least one binary filter, and a size value of a vector for a convolution filter.

The second neural network may include one or more convolutional layers each of which includes a generalization function, a binary activation function, a binary convolution function, and an activation function.

The binary multiplicative factors and the binary constant factor may be inserted as weights of the convolution filter in the second neural network.

The binary orthogonal vector may be a Hadamard matrix.

The binary activation function may include a sign function

Furthermore, according to an exemplary embodiment of the present disclosure, an apparatus for generating a binary neural network may comprise a processor; and a memory storing at least one instruction executable by the processor, wherein when executed by the processor, the at least one instruction causes the processor to: extract real-value filter weights from a first neural network for which inference training has been completed; perform a binary orthogonal transform on the filter weights; and generate a second neural network using binary weights calculated according to the binary orthogonal transform.

The first neural network may be a convolutional neural network, and the filter weights may include multiplicative factors and a constant factor of convolution filters.

In the performing of the binary orthogonal transform on the filter weights, the at least one instruction may further cause the processor to: generate a binary orthogonal vector; generate at least one binary filter by extracting each column of the binary orthogonal vector; and calculate binary multiplicative factors and a binary constant factor using the at least one binary filter.

The binary multiplicative factors and the binary constant factor may be generated using an equation represented using a vector for a real-value convolution filter included in the first neural network, a vector for the at least one binary filter, and a size value of a vector for a convolution filter.

The second neural network may include one or more convolutional layers each of which includes a generalization function, a binary activation function, a binary convolution function, and an activation function.

The binary multiplicative factors and the binary constant factor may be inserted as weights of the convolution filter in the second neural network.

The binary orthogonal vector may be a Hadamard matrix.

The binary activation function may include a sign function.

According to the exemplary embodiments of the present disclosure as described above, it is possible to provide inference performance close to that of an artificial neural network having full-precision while maintaining an inference speed provided by a lightweight neural network. That is, it is possible to obtain superior performance compared to the existing binary artificial neural network, and at the same time, the speed improvement effect through binary operations can also be expected.

### BRIEF DESCRIPTION OF DRAWINGS

Embodiments of the present disclosure will become more apparent by describing in detail embodiments of the present disclosure with reference to the accompanying drawings, in which:

FIG. 1 is a table showing performance characteristics according types of artificial neural networks;

FIG. 2 is a conceptual diagram illustrating a binary neural network generating apparatus according to an exemplary embodiment of the present disclosure;

FIGS. 3A and 3B are structural diagrams illustrating convolutional layers inside artificial neural networks used in an inference model;

FIG. 4 illustrates various binarization functions and function plots corresponding thereto;

FIG. 5 is a block diagram illustrating a convolutional layer in an artificial neural network according to an exemplary embodiment of the present disclosure;

FIG. 6 is a diagram illustrating a detailed concept of a weight binarization scheme according to an exemplary embodiment of the present disclosure;

FIG. 7 is a diagram illustrating a process of generating a Hadamard matrix applied to exemplary embodiments of the present disclosure;

FIG. 8 is a flowchart for describing a method of generating a binary neural network according to an exemplary embodiment of the present disclosure; and

FIG. 9 is a block diagram illustrating a binary neural network generating apparatus according to an exemplary embodiment of the present disclosure.

It should be understood that the above-referenced drawings are not necessarily to scale, presenting a somewhat simplified representation of various preferred features illustrative of the basic principles of the disclosure. The specific design features of the present disclosure, including, for example, specific dimensions, orientations, locations, and shapes, will be determined in part by the particular intended application and use environment.

### DETAILED DESCRIPTION OF THE EMBODIMENTS

Embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The present disclosure relates to a technology related to deep learning and model compression of a CNN model in the field of artificial intelligence, and more specifically, to binarization, a 1-bit quantization scheme among n-bit quantization techniques for compression of the CNN model.

In the exemplary embodiments of the present disclosure, a method of transforming floating point weight values (e.g., 32-bit floating point values (FP32)) in a conventional CNN into a binary form through direct calculation is proposed. When the method according to the present disclosure is used, a performance superior to that of a conventional binary artificial neural network can be obtained, and at the same time, a speed improvement effect through binary operations can also be expected. In addition, most of training processes for achieving this can be omitted and information loss can be eliminated. The method proposed in the present disclosure is also a mathematically closed-form solution.

Hereinafter, preferred exemplary embodiments of the present disclosure will be described in detail with reference to the accompanying drawings.

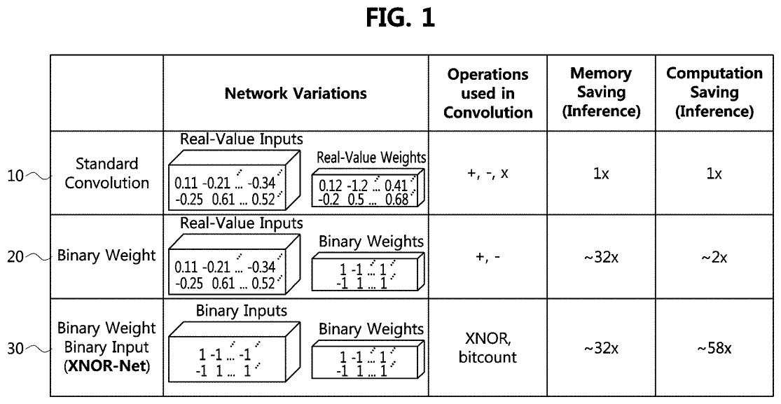

FIG. 1 is a table showing performance characteristics according types of artificial neural networks.

FIG. 1 shows operations, memory saving, and computation saving in an artificial neural network 20 using binary weights and an artificial neural network 30 using binary weights and binary inputs, respectively, as compared to a conventional convolutional artificial neural network 10. An example of a typical neural network that uses binary weights and binary inputs is ‘XNOR-Net’.

The binary neural network is a network that quantize weights and activation functions of an existing convolutional artificial neural network to 1-bit values. The size of the model can be dramatically reduced by quantizing the existing 32-bit floating point values to 1-bit values of {+1, −1}. In addition, in case of a convolution of binary values, an XNOR operation as a sign operation and a POPCOUNT operation for counting the number of bits can be performed at once. Using this operation scheme, when operating on a processor that supports up to 64 bits, 64 bits are processed at a time, and a speed gain of approximately 60 times can be expected.

Referring to FIG. 1, when computing devices that use 32-bit or 64-bit variables for the binary artificial neural network are used, 64 −1s and +1s can be computed as one operation by compressing them into 1 bit, and about 60 times the computation speed can be achieved compared to the standard convolution. This operation is possible only when the inputs of the artificial neural network, and the weights and filters inside the neural network are all binarized to 1 bits.

In the present disclosure, a binary neural network using an input binarization scheme and a weight binarization scheme is proposed. According to the present disclosure, not only the speed improvement effect of the artificial neural network can be obtained, but also the accuracy of inference can be greatly improved.

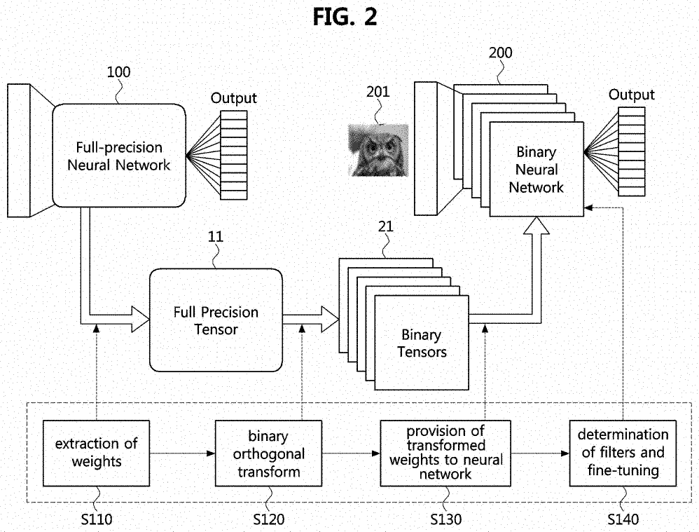

FIG. 2 is a conceptual diagram illustrating a binary neural network generating apparatus according to an exemplary embodiment of the present disclosure.

A binary neural network generating apparatus according to exemplary embodiments of the present disclosure uses a general artificial neural network 100 having general FP32 values. A typical artificial neural network with full-precision can make precise predictions in many areas, but it is difficult to use in most edge devices because the size of the model is too large.

Accordingly, in the present disclosure, in order to binarize such the general artificial neural network, a full precision tensor 11 which is a multidimensional matrix may be generated by extracting floating-point weights from the general artificial neural network 100. In this case, the artificial neural network that can be used in the present disclosure may be any convolutional neural network. The convolutional neural network may be, for example, AlexNet, ResNet, NasNet, or the like.

Thereafter, in the present disclosure, a binary tensor 21, which is a binary matrix, may be generated by performing binarization on the multidimensional matrix composed of floating-point weights. The generated binary matrix 21 may be provided to a binary artificial neural network 200 according to an exemplary embodiment of the present disclosure. The binary artificial neural network 200 according to an exemplary embodiment of the present disclosure may receive an input such as an image file 201 shown in FIG. 2 in a mobile edge computing environment, perform inference, and output a result value according to the inference.

FIG. 2 also shows a sequence of operations of a binary artificial neural network generating method that can be performed in the binary neural network generating apparatus according to an exemplary embodiment of the present disclosure.

In the binary neural network generating method according to an exemplary embodiment of the present disclosure, first, all weights of the conventional artificial neural network 100 may be extracted (S110). Each of the extracted weights may be compressed by a tensor scheme, and binarization using orthogonal matrices may be performed on them (S120). The orthogonally transformed weights (i.e., in form of a binary tensor) may be input to the binary artificial neural network 200 according to the present disclosure (S130). Thereafter, filters of the neural network may be determined using the orthogonally transformed binary weights, and the neural network binarization according to the present disclosure may be completed through fine-tuning (S140) for the binary neural network 200.

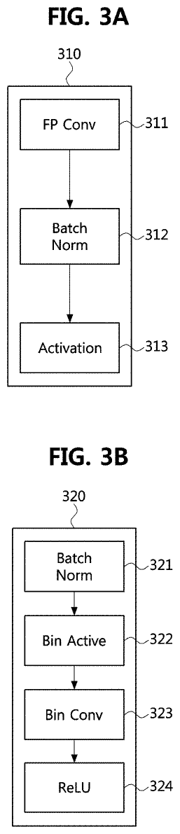

FIGS. 3A and 3B are structural diagrams illustrating convolutional layers inside artificial neural networks used in an inference model.

The artificial neural network is the most commonly used technology for machine learning. When data to be inferred is input to the artificial neural network, the artificial neural network is trained using a method of training characteristics of the data into neurons based on multiple layers composed of numerous neurons. The convolutional neural network is one of the artificial neural networks, and is used to analyze data more easily by using convolutions of the input data and filters. The convolutional neural network is mainly used in fields where a large amount of visual information is used, and despite training a large amount of data, its inference accuracy is high and thus its utilization is high.

FIG. 3A shows a layer using a conventional full-precision convolution of floating-point values and a convolution layer 310 in this case may comprise a convolution function 311, a partial normal distribution generalization (i.e., batch normalization) function 312, and an activation function 313.

FIG. 3B shows a convolutional layer of an artificial neural network using input binarization. A convolutional layer 320 may comprise a generalization function, such as a batch normalization function 321, a binary activation function 322, a binary convolution function (i.e., ‘Bin Cony’) 323, and a rectified linear Unit (ReLU) 324, which is an activation function.

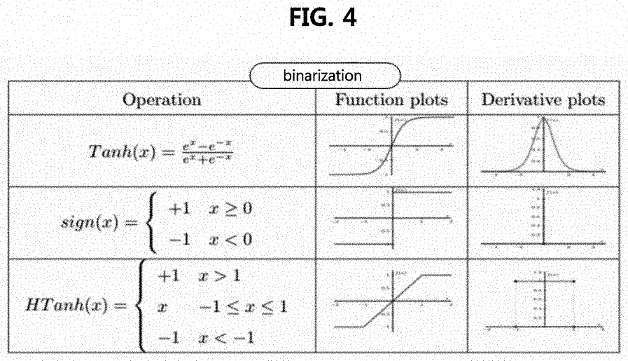

The binary activation function may be used to perform binarization on the inputs. Various binarization schemes may be used, and FIG. 4 shows several binarization functions and function plots corresponding thereto. Referring to FIG. 4, the binarization may be understood as a process of simplifying the input data as (−1) or (+1), and the binarization operations may include a hyperbolic tangent function (i.e., Tanh(x)), a sign function (i.e., sign(x)), H Tanh(x), and the like may be used. In FIG. 4, function plots and derivative plots for the respective functions are shown together.

According to a preferred exemplary embodiment of the present disclosure, functions based on the sign function may be used for the binarization. In the binary convolutional layer 320, inputs as well as binary weights should be binarized in order to benefit in the computation speed. When the binary activation function that performs binarization on the inputs is first performed and the generalization is performed later, information loss may occur and the inputs may become floating point values again. Therefore, before performing the input binarization, the inputs may be generalized first (i.e., at 321) to arrange the data based on an average of 0. Thereafter, the inputs may be binarized (i.e., at 322), and then the binary convolution function 323 and the activation function (e.g., ReLU) 324 may be performed.

As shown in FIG. 3B, the binary artificial neural network has been spotlighted for an increase in speed during inference and a decrease in memory during storing values, but the disadvantage of the binarization is revealed when training. More specifically, such the binary artificial neural network may not be able to binarize gradient values, but rather, the training speed may be slower than that of the conventional convolutional neural network due to the increased number of functions and the complexity of the gradient operations.

In this reason, in the present disclosure, a method of taking advantage of both the non-binarized artificial neural network and the binarized artificial neural network is selected.

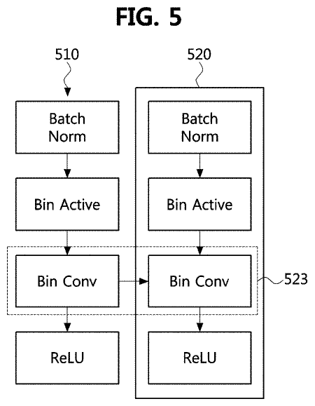

FIG. 5 is a block diagram illustrating a convolutional layer in an artificial neural network according to an exemplary embodiment of the present disclosure.

Although an artificial neural network 520 according to a preferred exemplary embodiment of the present disclosure is similar to the configuration of the binarized artificial neural network shown in FIG. 3B, the configuration of the convolution function is different. That is, all the problems occurring when training a binary artificial neural network can be avoided by training to derive the most precise results using the full precision convolution functions and then immediately binarizing the trained convolution functions (at 523).

In summary, the convolutional layer 520 of the artificial neural network according to exemplary embodiments of the present disclosure may transform filter weights derived by training an artificial neural network 510 using full-precision convolution functions, and use them as weights of the convolution functions of the binary artificial neural network 520. Accordingly, the convolutional layer 520 of the artificial neural network according to the exemplary embodiment of the present disclosure may comprise a batch normalization (i.e., ‘Batch Norm’), a binary activation function 322, a binary convolution function (i.e., ‘Bin Conv’), and an activation function (i.e., ReLU) 324. In this case, the binary convolution function may have filter weights that have been binarized through the weight transformation process, that is, binary multiplicative factors and a binary constant factor.

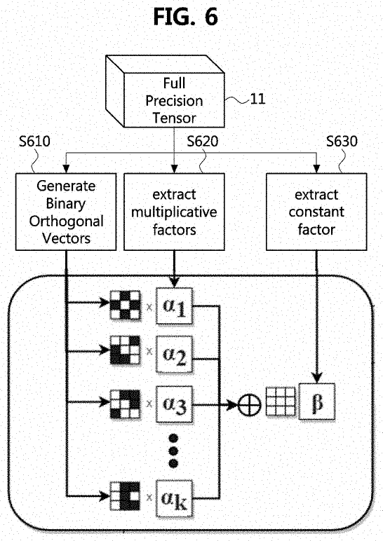

FIG. 6 is a diagram illustrating a detailed concept of a weight binarization scheme according to an exemplary embodiment of the present disclosure.

A method of binarizing the weights of the artificial neural network filter according to an exemplary embodiment of the present disclosure may comprise a step S610 of generating a binary orthogonal vector from the full precision tensor 11 composed of floating-point weights extracted from a well-trained general artificial neural network, a step S620 of extracting multiplicative factors, and a step S630 of extracting a constant factor.

Hereinafter, a method of binarizing the weights will be described in more detail.

The convolutional neural network to which the present disclosure is applied may be expressed as Equation 1 below.

W≈Σₖ₌₁^{K}αₖBₖ+β1_{N} [Equation 1]

Here, W is a real value filter, αₖ is a multiplicative factor to be used in a binary filter, and β is a constant factor to be used in the binary filter. In addition, Bₖ denotes a binary filter to be generated according to an exemplary embodiment of the present disclosure, and ‘1’ denotes a constant binary filter composed of all 1s. That is, the real value filter may be expressed through a plurality of binary filters, a constant filter composed of all 1s, and factors. In this case, even when the number of binary filters increases, the performance improvement effect provided by the binary operations themselves is so excellent that high accuracy and fast operations are possible. For example, since the convolution operation follows the commutative law and the associative law, the relationship as shown in Equation 2 below may be established.

I⊙W=I⊙{αB+β1}≈α{I⊙B}+β{I⊙1} [Equation 2]

Assuming that the input is I, a real value convolution filter is W, and the convolution operation is represented as a symbol ‘⊙’, it can be confirmed that binary operations are still possible even if the operation of the conventional real value convolution filter is changed to a binarized form including the factors. Here, in the equation of the original real value convolution filter, assuming that the matrix W is substituted with a vector w and the matrix B is substituted with a vector b, and assuming a case the a single value is used for K (i.e., k=1), and b=sign(w), for the convenience of calculation, Equation 3 below may be established.

w≈αb+β1 [Equation 3]

In addition, in order to obtain values of b, α, and β approximating w, Equation 4 for minimizing an error between them may be expressed as follows.

$${min}_{α , β} {‖ w - α b - β1 ‖}^{2} \qquad [ Equation 4 ]$$

When the values for each other are calculated by partial derivatives for each α and β values, they may be expressed as Equation 5 below.

$$α = \frac{1}{M} {w}^{T} b - \frac{1}{M} β {1}^{T} b , β = \frac{1}{M} {w}^{T} 1 - \frac{1}{M} α {b}^{T} 1 \qquad [ Equation 5 ]$$

Equation 5 may be expressed as Equation 6 below.

$$α = \frac{{w}^{T} b - \frac{1}{M} {w}^{T} 1 {1}^{T} b}{M - \frac{1}{M} {b}^{T} 1 {1}^{T} b} , β = \frac{1}{M} {w}^{T} 1 - \frac{1}{M} α {b}^{T} 1 \qquad [ Equation 6 ]$$

Here, M is the size of the vector w. That is, b using one binary filter is close to sign(w), and through this, values of α and β may be calculated directly.

Additionally, in the present disclosure, an orthogonal vector is used to construct a binary filter. In an exemplary embodiment of the present disclosure, a Hadamard matrix may be used as an example of the orthogonal vector.

When each component is given an N×N matrix each component of which is configured as {−1, 1}, and such the matrix H_{N} has the property defined by Equation 7 below, it may be referred to as an ‘N-order Hadamard matrix’.

$${\{ {H}_{N}^{T} {H}_{N} \}}_{i , j} = \{ \begin{matrix}N & i = j \\ 0 & i \neq j\end{matrix} \qquad [ Equation 7 ]$$

That is, the Hadamard matrix refers to a matrix in which row vectors and column vectors are orthogonal to each other because all components in the matrix are 1 or −1.

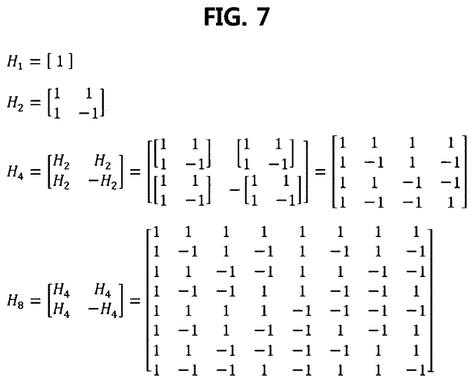

FIG. 7 is a diagram illustrating a process of generating a Hadamard matrix applied to exemplary embodiments of the present disclosure.

FIG. 7 shows a process of generating an eighth-order Hadamard matrix from a first-order Hadamard matrix. A main feature of the Hadamard Matrix is that the columns and rows are all orthogonal to each other. That is, a dot product of vectors for an arbitrary i-th column and an arbitrary j-th column (when i≠j) is always 0.

In the present disclosure, after constructing a binary filter by extracting the columns of the Hadamard matrix having such the property, the factors can be transformed directly without data or additional training using the property. Returning to Equation 3 for the convolution filter, when the number of binary filters of the corresponding equations is expanded to K greater than 1, Equation 3 may be summarized as Equation 8 below.

W≈Σₖ₌₁^{K}αₖbₖ+β1 [Equation 8]

In Equation 8, it is necessary to satisfy the condition according to Equation 9 below in order to obtain values of b, α, and β that will be close to w.

$${min}_{α , β} {‖ w - {\sum }_{k = 1}^{K} {α}_{k} {b}_{k} + β1 ‖}^{2} \qquad [ Equation 9 ]$$

If a general binary filter is used as the binary filter b, calculation may be impossible because the number of combinations is infinite. Accordingly, in the present disclosure, the columns of the Hadamard matrix are extracted, one by one from the first column, and used as the binary filter b. Using this scheme, the binary filter itself may not need to be stored. Above all, because of the orthogonal property, most of the values become 0 in obtaining a certain value, so direct reduction is possible.

In summary, the multiplicative factor α and the constant factor β to be used in the binary filter may be summarized as shown in Equation 10 below.

$${α}_{k} = \frac{{w}^{T} {b}_{k} - \frac{1}{M} {w}^{T} 1 {1}^{T} {b}_{k}}{M - \frac{1}{M} {b}_{k}^{T} 1 {1}^{T} {b}_{k}} \\ β = \frac{1}{M} {w}^{T} 1 - \frac{1}{M} {α}_{k} {b}_{k}^{T} 1 \qquad [ Equation 10 ]$$

That is, if the k-th column bₖ of the Hadamard matrix is extracted, the values of α and β may be directly derived independently of other k-th columns with only the existing values of w and b. Here, M is the size of the vector.

The values derived by this direct calculation are already optimal values, so additional training is not required. Table 1 below shows the accuracy of inference performance by processor model (i.e., AlexNet, VGG-11, ResNet-18).

TABLE 1

| Accuracy (%) | Original | XNOR-Net | Proposed one |
|---|---|---|---|
| AlexNet | 88.98 | 84.15 | 88.39 |
| VGG-11 | 91.73 | 86.78 | 91.65 |
| ResNet-18 | 93.53 | 90.51 | 93.33 |

Looking at Table 1, it can be seen that the method according to the exemplary embodiment of the present disclosure exhibits far superior performance than the industry standard XNOR-Net, and even exhibits an accuracy close to that of the original. Here, the original represents an artificial neural network with full-precision that is not lightened or binarized.

Table 2 is a table comparing the accuracies of the weighted binarization algorithms.

TABLE 2

| Used model, | | |
|---|---|---|
| accuracy (%) | Original (Top-1/Top-5) | Proposed one (Top-1/Top-5) |
| ResNet-18 | 69.76/89.08 | 69.41/88.92 |
| ResNet-50 | 76.15/92.87 | 75.99/92.85 |
| VGG-11 | 69.02/88.63 | 68.92/88.59 |
| VGG-19 | 72.38/90.88 | 71.91/90.56 |
| SqueezeNet 1.1 | 58.19/80.62 | 58.18/80.47 |
| MNASNET 1.0 | 73.51/91.54 | 73.35/91.38 |

Simply looking at the weighted binarization algorithm itself, the method according to the exemplary embodiment of the present disclosure shows an error of less than 1% compared to the original.

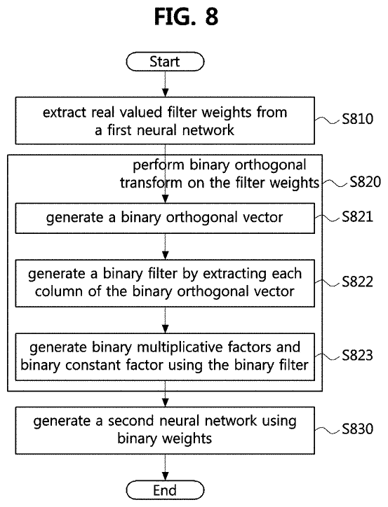

FIG. 8 is a flowchart for describing a method of generating a binary neural network according to an exemplary embodiment of the present disclosure.

The binary neural network generating method according to an exemplary embodiment of the present disclosure may be performed by a binary neural network generating apparatus, for example, a user terminal or an edge terminal, but the operation subject is not limited thereto.

Referring to FIG. 8, the binary neural network generating may extract real-value filter weights from a first neural network (S810). In this case, the first neural network may be an artificial neural network in a state in which training for inference has been completed.

The binary neural network generating apparatus may perform binary orthogonal transformation on the filter weights extracted from the first neural network (S820). In the binary orthogonal transformation step (S820), a binary orthogonal vector may be generated from the filter weights (S821), and each column of the binary orthogonal vector may be extracted to generate at least one binary filter (S822). In addition, binary multiplicative factors and a binary constant factor may be calculated using the at least one generated binary filter (S823).

Here, the binary multiplicative factors and the binary constant factor may be calculated by an equation expressed using a vector for real convolution filters included in the first neural network, a vector for the at least one binary filter, and a size value of a convolution filter.

The binary artificial neural network generating apparatus may generate a second neural network using the binary weights calculated according to the binary orthogonal transformation, that is, the binary multiplicative factors and the binary constant factor (S830).

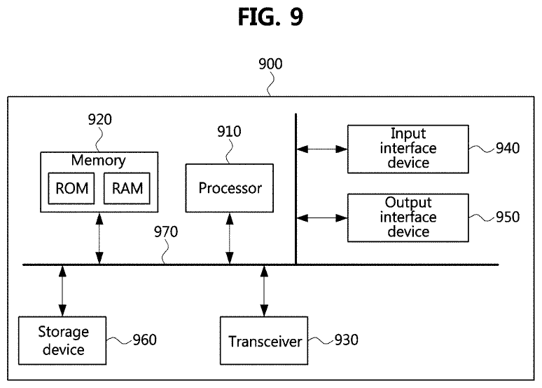

FIG. 9 is a block diagram illustrating a binary neural network generating apparatus according to an exemplary embodiment of the present disclosure.

A binary neural network generating apparatus 900 according to an exemplary embodiment of the present disclosure may comprise at least one processor 910, a memory 920 storing at least one instruction executable by the processor 910, and a transceiver 930 connected to a network to perform communication.

In addition, the apparatus 900 may further include an input interface device 940, an output interface device 950, a storage device 860, and the like. The components included in the apparatus 900 may be connected by a bus 970 to communicate with each other.

The processor 910 may execute the at least one instruction stored in at least one of the memory 920 and the storage device 960. The processor 910 may refer to a central processing unit (CPU), a graphics processing unit (GPU), or a dedicated processor on which the methods according to the exemplary embodiments of the present disclosure are performed. Each of the memory 920 and the storage device 960 may be configured as at least one of a volatile storage medium and a nonvolatile storage medium. For example, the memory 920 may be configured with at least one of a read only memory (ROM) and a random access memory (RAM).

Here, the at least one instruction may cause the processor to: extract real-value filter weights from a first neural network for which inference training has been completed; perform a binary orthogonal transform on the filter weights; and generate a second neural network using binary weights calculated according to the binary orthogonal transform.

The first neural network may be a convolutional neural network, and the filter weights may include multiplicative factors and a constant factor of convolution filters.

In the performing of the binary orthogonal transform on the filter weights, the at least one instruction may further cause the processor to: generate a binary orthogonal vector; generate at least one binary filter by extracting each column of the binary orthogonal vector; and calculate binary multiplicative factors and a binary constant factor using the at least one binary filter.

The binary multiplicative factors and the binary constant factor may be calculated using an equation represented using a vector for a real-value convolution filter included in the first neural network, a vector for the at least one binary filter, and a size value of a vector for a convolution filter.

The second neural network may include one or more convolutional layers each of which includes a generalization function, a binary activation function, a binary convolution function, and an activation function.

The binary multiplicative factors and the binary constant factor may be inserted as weights of the convolution filter in the second neural network.

The binary orthogonal vector may be a Hadamard matrix.

The binary activation function may include a sign function.

The method according to the exemplary embodiments of the present disclosure may also be embodied as computer readable programs or codes on a computer readable recording medium. The computer readable recording medium is any data storage device that may store data which can be thereafter read by a computer system. The computer readable recording medium may also be distributed over network coupled computer systems so that the computer readable code is stored and executed in a distributed fashion.

In addition, examples of the computer-readable recording medium may include magnetic media such as hard discs, floppy discs, and magnetic tapes, optical media such as compact disc-read-only memories (CD-ROMs), digital video disc (DVDs), and so on, magneto-optical media such as floptical discs, and hardware devices specially configured (or designed) for storing and executing program commands, such as ROMs, random access memories (RAMs), flash memories, and so on. Examples of a program command may not only include machine language codes, which are created by a compiler, but may also include high-level language codes, which may be executed by a computer using an interpreter, and so on.

Some aspects of the present disclosure have been described in the context of an apparatus but may also represent the corresponding method. Here, a block or the apparatus corresponds to an operation of the method or a characteristic of an operation of the method. Likewise, aspects which have been described in the context of the method may be indicated by the corresponding blocks or items or characteristics of the corresponding apparatus. Some or all of operations of the method may be performed by (or using) a hardware device, such as a microprocessor, a programmable computer, or an electronic circuit. In some exemplary embodiments, one or more important steps of the method may be performed by such a device. In the exemplary embodiments of the present disclosure, a programmable logic device (e.g., a field-programmable gate array (FPGA)) may be used to perform some or all of functions of the above-described methods. In the exemplary embodiments, the FPGA may operate in combination with a microprocessor for performing one of the above-described methods. In general, the methods may be performed by any hardware device.

While the exemplary embodiments of the present disclosure and their advantages have been described in detail, it should be understood that various changes, substitutions and alterations may be made herein without departing from the scope of the disclosure.

What is claimed is:

1. A method for generating a binary neural network, the method comprising:
extracting real-value filter weights from a first neural network for which inference training has been completed;
performing a binary orthogonal transform on the filter weights; and
generating a second neural network using binary weights calculated according to the binary orthogonal transform.

2. The method according to claim 1, wherein the first neural network is a convolutional neural network, and the filter weights include multiplicative factors and a constant factor of convolution filters.

3. The method according to claim 1, wherein the performing of the binary orthogonal transform on the filter weights comprises:
generating a binary orthogonal vector;
generating at least one binary filter by extracting each column of the binary orthogonal vector; and
calculating binary multiplicative factors and a binary constant factor using the at least one binary filter.

4. The method according to claim 3, wherein the binary multiplicative factors and the binary constant factor are generated using an equation represented using a vector for a real-value convolution filter included in the first neural network, a vector for the at least one binary filter, and a size value of a vector for a convolution filter.

5. The method according to claim 1, wherein the second neural network includes one or more convolutional layers each of which includes a generalization function, a binary activation function, a binary convolution function, and an activation function.

6. The method according to claim 3, wherein the binary multiplicative factors and the binary constant factor are inserted as weights of the convolution filter in the second neural network.

7. The method according to claim 3, wherein the binary orthogonal vector is a Hadamard matrix.

8. The method according to claim 5, wherein the binary activation function includes a sign function.

9. An apparatus for generating a binary neural network, the apparatus comprising a processor; and a memory storing at least one instruction executable by the processor, wherein when executed by the processor, the at least one instruction causes the processor to:
extract real-value filter weights from a first neural network for which inference training has been completed;
perform a binary orthogonal transform on the filter weights; and
generate a second neural network using binary weights calculated according to the binary orthogonal transform.

10. The apparatus according to claim 9, wherein the first neural network is a convolutional neural network, and the filter weights include multiplicative factors and a constant factor of convolution filters.

11. The apparatus according to claim 9, wherein in the performing of the binary orthogonal transform on the filter weights, the at least one instruction further causes the processor to:
generate a binary orthogonal vector;
generate at least one binary filter by extracting each column of the binary orthogonal vector; and
calculate binary multiplicative factors and a binary constant factor using the at least one binary filter.

12. The apparatus according to claim 11, wherein the binary multiplicative factors and the binary constant factor are generated using an equation represented using a vector for a real-value convolution filter included in the first neural network, a vector for the at least one binary filter, and a size value of a vector for a convolution filter.

13. The apparatus according to claim 9, wherein the second neural network includes one or more convolutional layers each of which includes a generalization function, a binary activation function, a binary convolution function, and an activation function.

14. The apparatus according to claim 11, wherein the binary multiplicative factors and the binary constant factor are inserted as weights of the convolution filter in the second neural network.

15. The apparatus according to claim 11, wherein the binary orthogonal vector is a Hadamard matrix.

16. The apparatus according to claim 13, wherein the binary activation function includes a sign function.
